(19) United States
(12) Patent Application Publication
(10) Pub. No.: US 2004/0038667 A1
(43) Pub. Date: Feb. 26, 2004

(54) Secure remote access in a wireless telecommunication system

(76) Inventor: Charles Terry Vance JR., Atlanta, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/225,997

(22) Filed: Aug. 22, 2002

(51) Int. Cl. H04M 1/68

(52) U.S. Cl. 455/410; 455/411

(57) ABSTRACT

Providing secure remote access in a wireless telecommunication system comprises accessing a secure server by a user and validating the user. The validation may include a designation of at least a first system within the wireless telecommunication system that the user has been previously granted clearance to access. In addition, providing secure remote access in a wireless telecommunication system may comprise providing the use access to the first system within the wireless telecommunication system.

### FIELD OF THE INVENTION

The invention relates generally to systems and methods for providing remote access, and more particularly, to systems and methods for providing secure remote access in a wireless telecommunication system.

### BACKGROUND OF THE INVENTION

The use of telephone products and systems in the day-to-day lives of most people is continually growing. With the advent and steady growth of wireless telecommunications, wireless telecommunication systems will increasingly be utilized for not only voice data, but also for sending and receiving packetized data for use on the Internet, for example. In an effort to lower operating costs, increase system availability, and increase value for its subscribers, wireless telecommunications providers wish to provide secure remote access to various systems or subsystems within the wireless telecommunication system. Wireless telecommunication providers realize a time and a cost savings by remotely accessing systems within the wireless telecommunications system.

Therefore, the need to efficiently provide remote access in wireless telecommunication systems has become a common need for many wireless telecommunication providers. More specifically, providing secure remote access to systems within the wireless telecommunication system has become a critical operation for many wireless telecommunication providers. This is because in an increasingly competitive environment, meeting and exceeding the expectations of subscribers or others who receive services is essential for a wireless telecommunication provider.

One solution to the remote access problem is to provide an “all or nothing” approach where users are given access to any system in the wireless telecommunications system once access is made. For example, a user comprising a system operator in the field or a vendor, may dial into a gateway server in the wireless telecommunications system and given access using conventional methods. Once in, the user is presented with a command line and can then “telnet” to any desired system in the wireless telecommunications system. Telnet is a terminal emulation protocol commonly used on computer networks. It allows a user at a terminal or computer to log onto a remote device and run a program. Great inefficiencies are created in this procedure because, for example, once access is granted, the user can access any system connected to the network. In addition, this conventional solution does not conveniently allow for the archiving and analysis of logistical data, such as, which users are going to which systems and why. Accordingly, efficiently providing secure remote access in wireless telecommunication systems remains an elusive goal.

Thus, there remains a need to efficiently provide remote access in wireless telecommunication systems. In addition, there remains a need for providing secure remote access to systems within the wireless telecommunication system.

### SUMMARY OF THE INVENTION

Consistent with the present invention, methods and systems for providing secure remote access in a wireless telecommunication system are provided that avoid problems associated with prior methods and systems for providing secure remote access in a wireless telecommunication system as discussed herein above.

In one aspect, a method for providing secure remote access in a wireless telecommunication system comprises accessing a secure server by a user, validating the user, the validation including a designation of at least a first system within the wireless telecommunication system that the user has been previously granted clearance to access, and providing the user access to the first system within the wireless telecommunication system.

In another aspect, a system for providing secure remote access in a wireless telecommunication system comprises a secure server accessible by a user, a first component for validating the user, the validation including a designation of at least a first system within the wireless telecommunication system that the user has been previously granted clearance to access, and a second component for providing the user access to the first system within the wireless telecommunication system.

In yet another aspect, a computer-readable medium on which is stored a set of instructions for providing secure remote access in a wireless telecommunication system, which when executed perform stages comprising accessing a secure server by a user, validating the user, the validation including a designation of at least a first system within the wireless telecommunication system that the user has been previously granted clearance to access, and providing the user access to the first system within the wireless telecommunication system.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of an exemplary system for providing secure remote access in a wireless telecommunication system consistent with an embodiment of the present invention;

FIG. 2 is a flow chart of an exemplary method for providing secure remote access in a wireless telecommunication system consistent with an embodiment of the present invention;

FIG. 3 is a flow chart of an exemplary subroutine used in the exemplary method of FIG. 2 for accessing a secure server by a user consistent with an embodiment of the present invention;

FIG. 4 is an illustration an exemplary secure screen consistent with an embodiment of the present invention;

FIG. 5 is a flow chart of an exemplary subroutine used in the exemplary method of FIG. 2 for validating a user consistent with an embodiment of the present invention;

FIG. 6 is an illustration of an exemplary system screen consistent with an embodiment of the present invention;

FIG. 7 is a flow chart of an exemplary subroutine used in the exemplary method of FIG. 2 for providing a user with access to the first system within a wireless telecommunication system consistent with an embodiment of the present invention; and

FIG. 8 is an illustration of an exemplary reason solicitation screen consistent with an embodiment of the present invention.

### DESCRIPTION OF THE EMBODIMENTS

Reference will now be made to various embodiments according to this invention, examples of which are shown in the accompanying drawings and will be obvious from the description of the invention. In the drawings, the same reference numbers represent the same or similar elements in the different drawings whenever possible.

Consistent with the general principles of the present invention, a system for providing secure remote access in a wireless telecommunication system comprises a secure server accessible by a user, a first component for validating the user, the validation including at least a designation of at least a first system within the wireless telecommunication system that the user has been previously granted clearance to access, and a second component for providing the user access to the first system within the wireless telecommunication system.

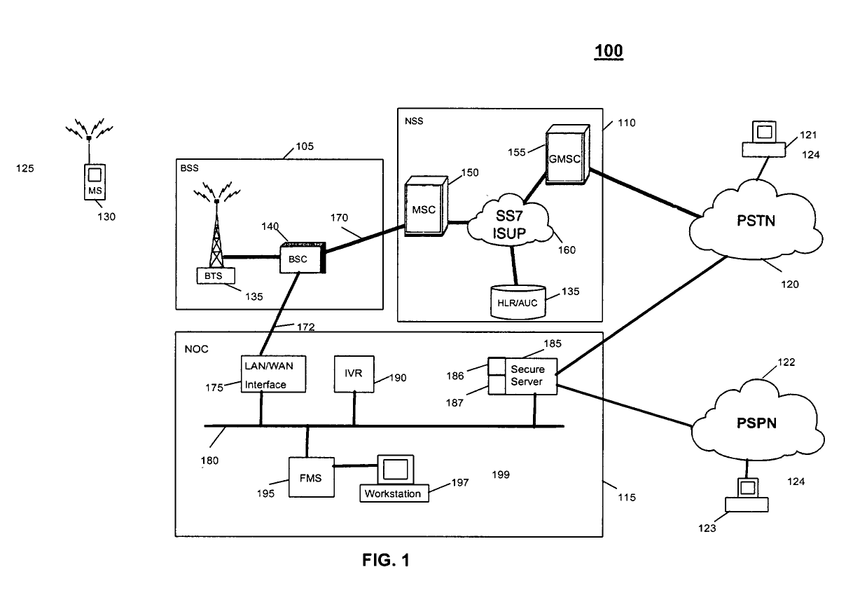

As herein embodied and illustrated in FIG. 1, a wireless telecommunication system 100 may comprise a base station subsystem (BSS) 105, a network and switching subsystem (NSS) 110, a network operation center (NOC) 115, a mobile station (MS) 130, a publicly switched telephone network (PSTN) 120, and a publicly switched packet network (PSPN) 122. The elements of system 100 will be described in greater detail below. Consistent with an embodiment of the invention, the secure server may comprise a secure server 185 (as described below). The first and second components may comprise secure server 185 in conjunction with PSTN 120 and a user device 121, or may comprise secure server 185 in conjunction with PSPN 122 and a user device 123. Those of ordinary skill in the art, however, will appreciate that other elements of system 100 may comprise the secure server, the first component, and the second component.

System 100 may utilize GSM technology enhanced with GPRS in embodiments of the present invention. Those of ordinary skill in the art will appreciate, however, that other wireless telecommunication technologies standards may be employed, for example, FDMA, TDMA, CDMA, UMTS, EDGE and CDMA2000, without departing from the spirit of the invention.

Wireless telecommunications may include radio transmission via the airwaves, however, those of ordinary skill in the art will appreciate that various other telecommunication techniques can be used to provide wireless transmission including infrared line of sight, cellular, microwave, satellite, blue-tooth, packet radio, and spread spectrum radio. Wireless data may include, but is not limited to, paging, text messaging, e-mail, Internet access, instant messaging, and other specialized data applications specifically excluding or including voice transmission.

As shown in FIG. 1, BSS 105 may comprise, for example, a base station controller (BSC) 140 and a base transceiver station (BTS) 135. BSS 105 connects to MS 130 through a radio interface and connects to NSS 115 through an interface 170. BSC 140 controls BTS 135 and may control a plurality of other base transceiver stations in addition to BTS 135. BTS 135 may comprise radio transmission and reception equipment located at an antenna site. Associated with BSS 105, a transcoder/rate adaptation unit (TRAU) (not shown) may perform speech encoding and speech decoding and rate adaptation for transmitting data. As a subpart of BTS 135, the TRAU may be located away from BTS 135, for example, at a mobile switching center located in NSS 110. When the TRAU is located in this way, the low transmission rate of speech code channels allows more compressed transmission between BTS 135 and the TRAU.

Interface 170 between NSS 110 and BSS 105, and a wide area network 172 between BSC140 and NOC 115, may comprise T-1 lines using X.25 or TCP/IP protocol, for example.

MS 130 may comprise a mobile phone, a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information. MS 130 may utilize cellular telephone protocols such as wireless application protocol (WAP). Those of ordinary skill in the art will recognize that other systems and components may be utilized within the scope and spirit of the invention.

Still referring to FIG. 1, NSS 110 may comprise a mobile switching center (MSC) 150, a first network 160, a home location register/authentication center (HLR/AUC) 135, and a gateway mobile switching center (GMSC) 155. NSS 110 manages the communication between subscribers, for example, an operator 125 using MS 130, and other telecommunications users, for example, those using publicly switched telephone network (PSTN) 120. PSTN 120 may comprise, for example, the worldwide voice telephone network.

MSC 150 coordinates call set-up to and from subscribers such as operator 125 using MS 130. MSC 150 may control several base station controllers such as, and similar to BSC 140. GMSC 110 is used to interface with external networks for communication with users outside of the wireless system, such users on PSTN 120.

HLR/AUC 135 may comprise a stand-alone computer without switching capabilities, a database which contains subscriber information, and information related to the subscriber's current location, but not the actual location of the subscriber. The AUC portion of HLR/AUC 135 manages the security data for subscriber authentication. Another sub-division of HLR/AUC 135 may include an equipment identity register (EIR) (not shown) which may store data relating to mobile equipment (ME).

NSS 110 may also include a visitor location register (VLR) (not shown). The VLR links to one or more mobile switching center located on other systems, temporarily storing subscription data of subscribers currently served by MSC 150. The VLR holds more detailed data than HLR/AUC 135. For example, the VLR may hold more current subscriber location information than the location information at HLR/AUC 230.

GMSC 155 is utilized to interface with PSTN 120. In order to set up a requested call, the call is initially routed to GMSC 155, that finds the correct home location register by knowing the director number of the subscriber. GMSC 155 has an interface with an external network, such as PSTN 120, for gatewaying communications.

The elements of NSS 110 are connected using first network 160. First network 160 may comprise an intelligent network utilizing signal system 7 (SS7) in an ISDN user part (ISUP) protocol. ISUP is used for both ISDN and non-ISDN calls. Calls that originate and terminate at the same switch do not use ISUP signaling.

Still referring to FIG. 1, network operation center (NOC) 115 may comprise a LAN/WAN interface 175, a local area network (LAN) 180, a secure server 185, a validation database 186, an access log database 187, an interactive voice response system (IVR) 190, a fault management system (FMS) 195, a workstation 197, and a NOC operator 199.

LAN/WAN interface 175 interfaces WAN 172 and LAN 180, thus connecting the elements connected to LAN 180 with BSC 140. From IVR 190, the data may then be pushed onto LAN 180 to a database server (not shown) and stored in database on the database server. The database server may comprise a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information.

Also connected to LAN 180 is secure server 185. Secure server 185 may comprise a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information as know by those of ordinary skill in the art. Validation database 186 and access log database 187 may be located on storage media in secure server 185 or other storage media in systems, servers, or components accessible by secure server 185.

PSPN 122, most often a publicly switched packet network such as the Internet, may be accessed by user 124 through user device 123 in a conventional manner as is know by those of ordinary skill in the art. Likewise, PSTN 120 be accessed by user 124 through user device 121 in a conventional manner as is know by those of ordinary skill in the art. Either through user device 121 or user device 123, user 124 may ultimately access secure server 185.

FMS 195 is a device used to detect, diagnose, and correct problems on system 100 effecting the security or reliability of system 100. Like secure server 185, FMS 195 may comprise a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information. Workstation 197 allows a NOC operator 199 to interface with FMS 195. Workstation 197 may comprise, for example, a scalable performance architecture (SPARC) station marketed by Sun Mircosystem, Inc. of 901 San Antonio Road Palo Alto, Calif. 94303-4900. SPARC is a family of 32-bit RISC CPUs developed by Sun Microsystems, Inc.

Method for Providing Secure Remote Access

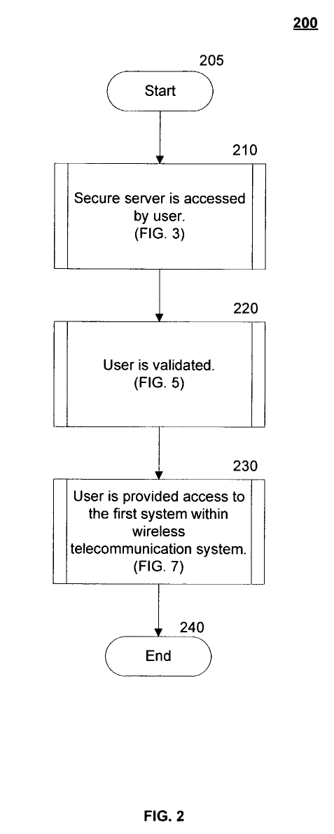

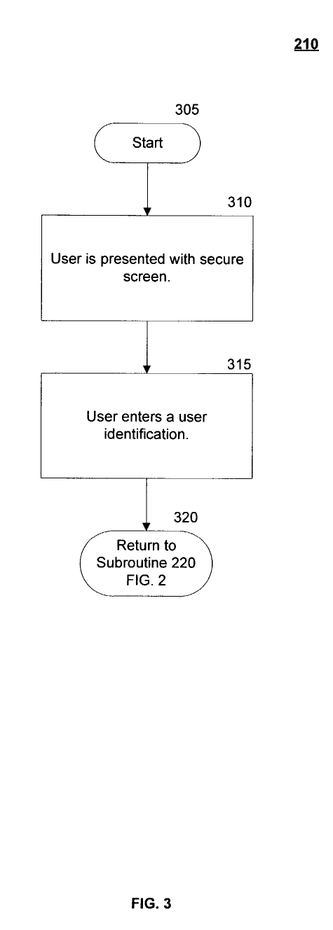

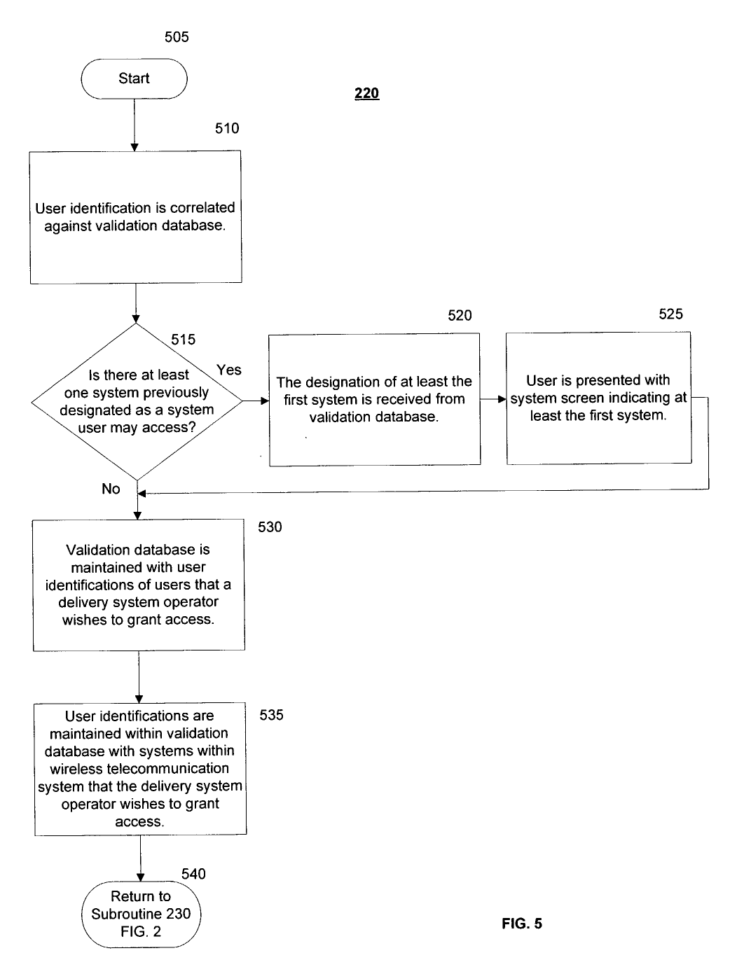

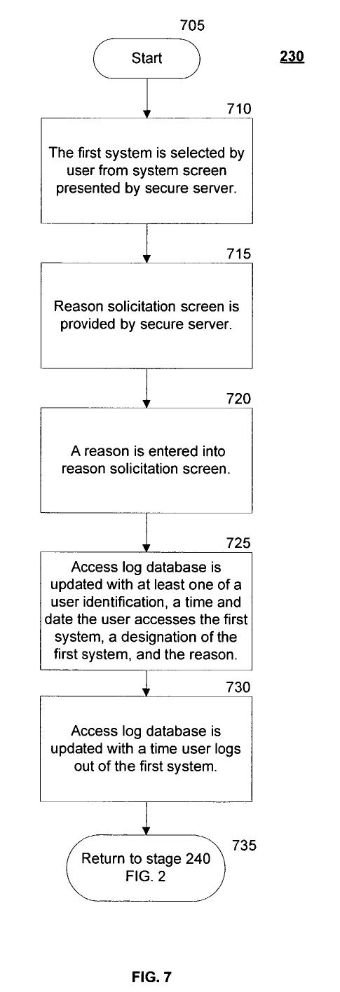

FIG. 2 is a flow chart setting forth the general stages involved in exemplary method for providing secure remote access in a wireless telecommunication system consistent with an embodiment of the present invention. The implementation of the stages of exemplary method 200 in accordance with an exemplary embodiment of the present invention will be described in greater detail in FIG. 3 through FIG. 8. Exemplary method 200 begins at starting block 205 and proceeds to exemplary subroutine 210 where secure server 185 is accessed by user 124. The stages of exemplary subroutine 210 are shown in FIG. 3 and will be described in greater detail below. From exemplary subroutine 210 where secure server 185 is accessed by user 124, exemplary method 200 continues to exemplary subroutine 220 where user 124 is validated. The stages of exemplary subroutine 220 are shown in FIG. 5 and will be described in greater detail below. Once user 124 is validated in exemplary subroutine 220, exemplary method 200 advances to exemplary subroutine 230 where user 124 is provided access to the first system within wireless telecommunication system 100. The stages of exemplary subroutine 230 are shown in FIG. 7 and will be described in greater detail below. From exemplary subroutine 230, exemplary method 200 ends at stage 240.

Accessing Secure Server by User

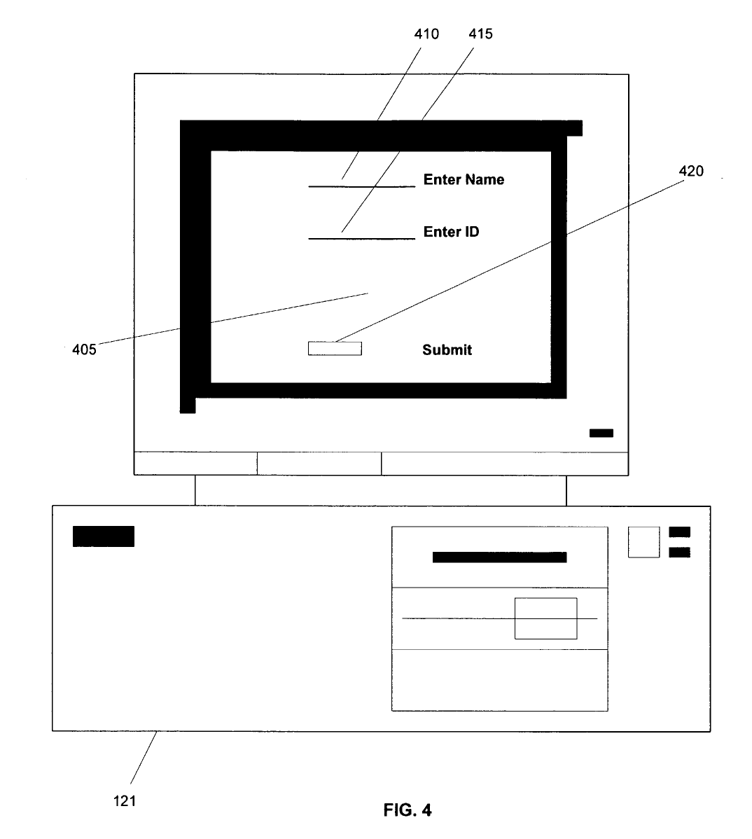

FIG. 3 describes exemplary subroutine 210 from FIG. 2 for accessing secure server 185 by user 124 consistent with an embodiment of the present invention. Exemplary subroutine 210 begins at starting block 305 and advances to stage 310 where user 124 is presented with secure screen 405, as illustrated in FIG. 4. For example, user 124 may access secure server 185 through either user device 121 and PSTN 120, or user device 123 and PSPN 122. Once accessed, secure server 185 may present a screen, such as secure screen 405 in order to obtain, for example, a user identification and name for user 124.

From stage 310 where user 124 is presented with secure screen 405, exemplary subroutine 210 advances to stage 315 where user 124 enters a user identification. For example, after secure screen 405 is presented to user 124, user 124 may enter a name and a user identification in name field 410 and identification filed 415 respectively. Once the name and the user identification are entered by user 124 in name field 410 and identification field 415 respectively, user 124 may click on a submit button 420 to send the data on secure screen 405 to secure server 185.

After user 124 enters a user identification, exemplary subroutine 210 continues to stage 320 and returns to subroutine 220 of FIG. 2.

Validating User

FIG. 5 describes exemplary subroutine 220 from FIG. 2 for validating user 124 consistent with an embodiment of the present invention. Exemplary subroutine 220 begins at starting block 505 and advances to stage 510 where user identification is correlated against validation database 186. For example, once the name and user identification are received by secure server 185, a correlation programming module located on secure server 185, for example, may be executed. The correlation programming module may open validation database 186 and search for a data record matching the user identification. If a match to the user identification is found, access may be granted to user 124.

Validation database 186, for example, may comprise a plurality of data records corresponding to a plurality of user identifications associated with users to whom the wireless telecommunication system wishes to allow access. Associated with the data records of validation database 186 may be a system or systems within wireless telecommunications system 100 that the corresponding users are clear to access remotely.

From stage 510 where the user identification is correlated against validation database 186, exemplary subroutine 220 advances to decision block 515 where it is determined if there is at least one system previously designated as a system user 124 may access. For example, once a match in validation database 186 is found, the matching data record in validation database 186 indicates which system or systems may be accessed by user 124.

If it is determined at decision block 515 that there is at least one system previously designated as a system user 124 may access, exemplary subroutine 220 advances to stage 520 where the designation of at least the first system is received from validation database 186. For example, once a match in validation database 186 is found, the system or systems within wireless telecommunication system 100 that the operator of wireless communications system 100 will allow user 124 to access is obtained from the matching data record in validation database 186.

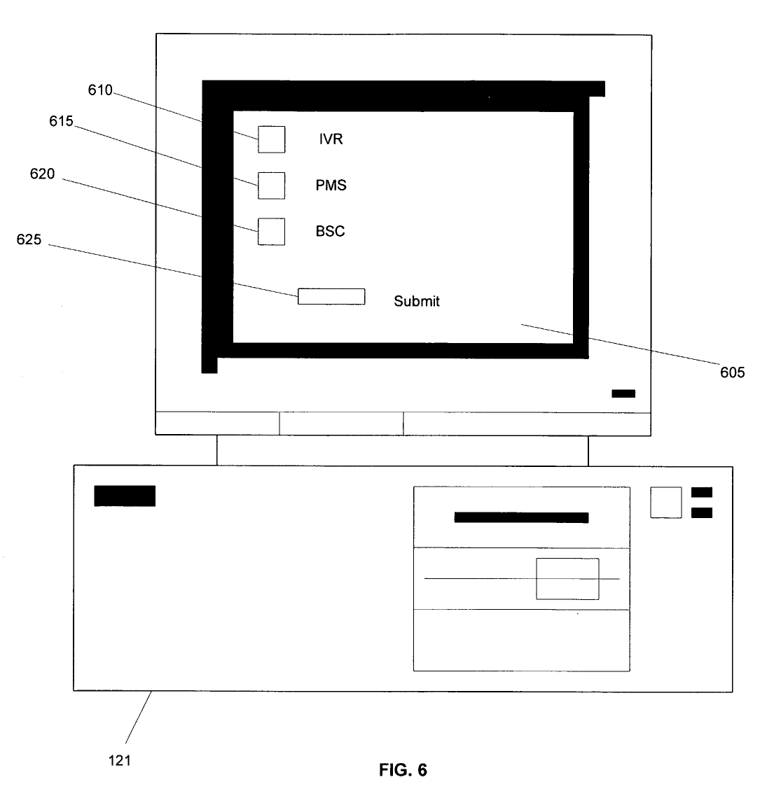

After the designation of at least the first system is received from validation database 186 in stage 520, exemplary subroutine 220 continues to stage 525 where user 124 is presented with system screen 605, as illustrated in FIG. 6, indicating at least the first system. For example, a list of systems that the wireless telecommunications system operator will allow user 124 access may be listed on system screen 605. As shown in FIG. 6, IVR 190, FMS 195, and BSC 140 may be listed as the systems with their corresponding selection boxes 410, 415, and 420 respectively. The first system, for example, may comprise IVR 190, FMS 195, BSC 140, BTS 135, or any other systems or subsystems as they are know by those of ordinary skill in the art.

From stage 525 where user 124 is presented with system screen 605 indicating at least the first system, or from decision block 515, if it is not determined that there is at least one system previously designated as a system user 124 may access, exemplary subroutine 220 advances to stage 530 where validation database 187 is maintained with user identifications of users that a delivery system operator wishes to grant access. For example, validation database 187 may periodically require the addition or deletion of user identifications corresponding to users cleared to access systems in wireless telecommunications system 100. This may be due to the fact that vendors may be granted temporary access for a specified period, or operations personnel may become employed or unemployed with the operator of system 100.

Once validation database 187 is maintained with user identifications of users that a delivery system operator wishes to grant access in stage 530, exemplary subroutine 220 continues to stage 535 where user identifications are maintained within validation database 187 with systems within wireless telecommunication system 100 that the wireless telecommunication system operator wishes to grant access. For example, users may be granted access to a specific system in system 100, however, that access may latter be restricted.

From stage 535 where user identifications are maintained within validation database 187 with systems within wireless telecommunication system 100 that the delivery system operator wishes to grant access, exemplary subroutine 220 advances to stage 540 and returns to subroutine 230 of FIG. 2.

Providing User with Access to the First System

FIG. 7 describes exemplary subroutine 230 from FIG. 2 for providing user 124 with access to the first system within wireless telecommunication system 100 consistent with an embodiment of the present invention. Exemplary subroutine 230 begins at starting block 705 and advances to stage 710 where the first system is selected by user 124 from system screen 605 presented by secure server 185, as shown in FIG. 6. For example, if user 124 wishes to access IVR 190, user 124 may click on selection box 610 and then click on submit button 625.

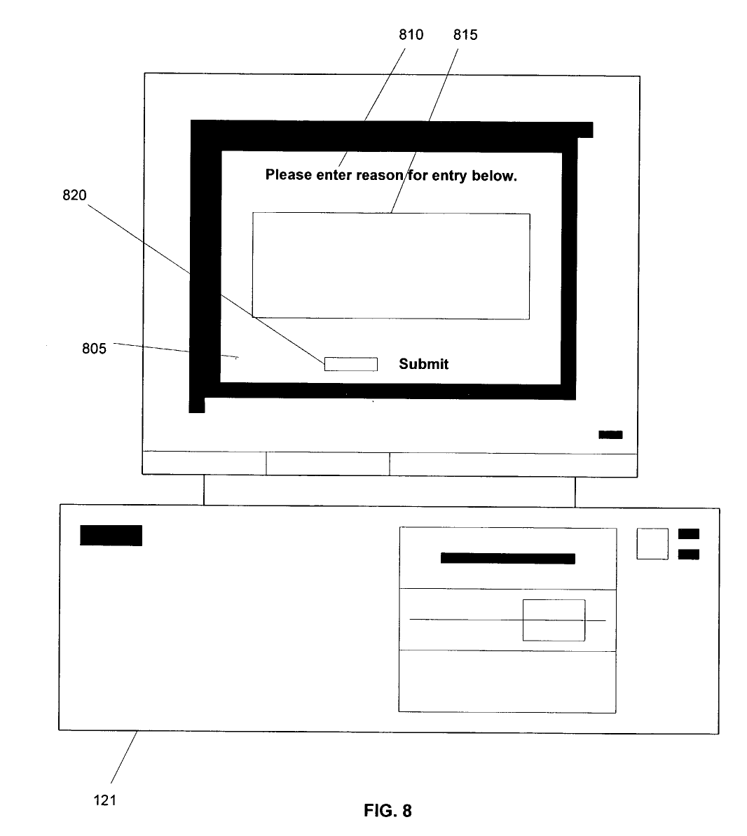

Once the first system is selected by user 124 from system screen 605 presented by secure server 185 in stage 710, exemplary subroutine 230 advances to stage 715 where a reason solicitation screen 805 is provided by secure server 185. For example, as shown in FIG. 8, an exemplary solicitation screen 805 may comprise an instruction area 810, an entry box 815, and a submit button 820.

After reason solicitation screen 805 is provided by secure server 185, subroutine 230 advances to stage 720 where a reason is entered into reason solicitation screen 805. For example, user 124 may type a short message into entry box 815 stating why it is necessary to access the selected system.

From stage 720 where the reason is entered into reason solicitation screen 805, exemplary subroutine 230 advances to stage 725 where access log database 187 is updated with at least one of a user identification, a time and date the user accesses the first system, a designation of the first system, and the reason. For example, when user 124 has entered the reason into entry box 815, user 124 may then click on submit button 820. When submit button 820 is clicked, the entry of the reason into access log database 187 may be stamped with at least one of a user identification, a time and date the user accesses the first system, and a designation of the first system.

Once access log database 187 is updated with at least one of a user identification, a time and date the user accesses the first system, a designation of the first system, and the reason, exemplary subroutine 230 advances to stage 730 where access log database 187 is updated with a time user 124 logs out of the first system. For example, when user 124 logs out of the system previously selected, the entry of the reason into access log database 187 may be further stamped with the log-out time. Access log database 187 may be access in the future to in order to evaluate how systems are being accessed. For example, it may be seen from access log database 187 which users are accessing which systems, and at what time the users enter and exit.

After access log database 187 is updated with a time user 124 logs out of the first system in stage 730, exemplary subroutine 230 continues to stage 735 and returns to stage 240 of FIG. 2.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for providing secure remote access in a wireless telecommunication system, comprising:
accessing a secure server by a user;
validating the user, the validation including designation of at least a first system within the wireless telecommunication system that the user has been previously granted clearance to access; and
providing the user access to the first system within the wireless telecommunication system.

2. The method of claim 1, wherein accessing the secure server further comprises:
presenting the user with a secure screen; and
entering, by the user, a user identification.

3. The method of claim 1, wherein validating the user further comprises:
correlating a user identification against a validation database;
receiving from the validation database the designation of at least the first system if the first system has been previously designated as a system the user may access; and
presenting to the user a system screen indicating at least the first system.

4. The method of claim 3, further comprising:
maintaining the validation database with user identifications of users that a delivery system operator wishes to grant access; and
maintaining the user identifications within the validation database with systems within the wireless telecommunication system that the delivery system operator wishes to grant access.

5. The method of claim 1, wherein providing the user access to the first system further comprises:
selecting the first system by the user from a system screen presented by the secure server;
providing a reason solicitation screen by the secure server;
entering into the reason solicitation screen a reason, the reason comprising an indication why the user is seeking access to the first system; and
updating an access log database with at least one of a user identification, a time and date the user accesses the first system, a designation of the first system, and the reason.

6. The method of claim 5, further comprising:
updating the access log database with a time the user logs out of the first system.

7. The method of claim 1, wherein the first system comprises a switching system within the wireless telecommunication system.

8. The method of claim 1, wherein the first system comprises at least on of a base station controller (BSC), a base transceiver station (BTS), an IVR, and a fault management system (FMS).

9. The method of claim 1, wherein accessing the secure server further comprises obtaining access through at least one of a publicly switched telephone network (PSTN) and a publicly switched packet network (PSPN).

10. A system for providing secure remote access in a wireless telecommunication system, comprising:
a secure server accessible by a user;
a first component for validating the user, the validation including a designation of at least a first system within the wireless telecommunication system that the user has been previously granted clearance to access; and
a second component for providing the user access to the first system within the wireless telecommunication system.

11. The system of claim 10, wherein the secure server is further configured for:
presenting the user with a secure screen; and
receiving from the user a user identification.

12. The system of claim 10, wherein the first component is further configured for:
correlating a user identification against a validation database;
receiving from the validation database the designation of at least the first system if the first system has been previously designated as a system the user may access; and
presenting to the user a system screen indicating at least the first system.

13. The system of claim 12, wherein the first component is further configured for:
maintaining the validation database with user identifications of users that a delivery system operator wishes to grant access; and
maintaining the user identifications within the validation database with systems within the wireless telecommunication system that the delivery system operator wishes to grant access.

14. The system of claim 10, wherein the second component is further configured for:
receiving a selection of the first system from the user from a system screen;
providing a reason solicitation screen;
entering into the reason solicitation screen a reason, the reason comprising an indication why the user is seeking access to the first system; and
updating an access log database with at least one of a user identification, a time and date the user accesses the first system, a designation of the first system, and the reason.

15. The system of claim 14, wherein the second component is further configured for updating the access log database with a time the user logs out of the first system.

16. The system of claim 10, wherein the first system comprises a switching system within the wireless telecommunication system.

17. The system of claim 10, wherein the first system comprises at least on of a base station controller (BSC), a base transceiver station (BTS), an IVR, and a fault management system (FMS).

18. The system of claim 10, further comprising at least one of a publicly switched telephone network (PSTN) and a publicly switched packet network (PSPN), through which the secure server is accessed.

19. A computer-readable medium on which is stored a set of instructions for providing secure remote access in a wireless telecommunication system, which when executed perform stages comprising:
accessing a secure server by a user;
validating the user, the validation including a designation of at least a first system within the wireless telecommunication system that the user has been previously granted clearance to access; and
providing the user access to the first system within the wireless telecommunication system.

20. The computer-readable medium of claim 19, wherein accessing the secure server further comprises:
presenting the user with a secure screen; and
entering, by the user, a user identification.

21. The computer-readable medium of claim 19, wherein validating the user further comprises:
correlating a user identification against a validation database;
receiving from the validation database the designation of at least the first system if the first system has been previously designated as a system the user may access; and
presenting to the user a system screen indicating at least the first system.

22. The computer-readable medium of claim 21, further comprising:
maintaining the validation database with user identifications of users that a delivery system operator wishes to grant access; and
maintaining the user identifications within the validation database with systems within the wireless telecommunication system that the delivery system operator wishes to grant access.

23. The computer-readable medium of claim 19, wherein providing the user access to the first system further comprises:
selecting the first system by the user from a system screen presented by the secure server;
providing a reason solicitation screen by the secure server;
entering into the reason solicitation screen a reason, the reason comprising an indication why the user is seeking access to the first system; and
updating an access log database with at least one of a user identification, a time and date the user accesses the first system, a designation of the first system, and the reason.

24. The computer-readable medium of claim 23, further comprising updating the access log database with a time the user logs out of the first system.

25. The computer-readable medium of claim 19, wherein the first system comprises a switching system within the wireless telecommunication system.

26. The computer-readable medium of claim 19, wherein the first system comprises at least on of a base station controller (BSC), a base transceiver station (BTS), an IVR, and a fault management system (FMS).

27. The computer-readable medium of claim 19, wherein accessing the secure server further comprises obtaining access through at least one of a publicly switched telephone network (PSTN) and a publicly switched packet network (PSPN).
